(19) United States
(12) Patent Application Publication
(10) Pub. No.: US 2008/0120411 A1
(43) Pub. Date: May 22, 2008

(54) Methods and System for Social OnLine Association and Relationship Scoring

(76) Inventor: Oliver Eberle, Los Angeles, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/743,866

(22) Filed: May 3, 2007

Related U.S. Application Data
(60) Provisional application No. 60/866,743, filed on Nov. 21, 2006.

(51) Int. Cl. G06F 21/20

(52) U.S. Cl. 709/225

(57) ABSTRACT

A method and system adopting mathematical and vastly in-depth analytical resources in order to evaluate, measure and ultimately place a unique and highly determinative score that provides information on such items as the quality of individual relationships in on line social networks and the context and characteristics of these relationships.

This is a nonprovisional of application No. 60/866,743, which was filed on Nov. 11, 2006 and priority is hereby claimed.

### FIELD OF THE INVENTION

The present invention relates to methods for collecting relevant data parameters and the application of analytical algorithms to evaluate, measure, and ultimately place a unique determinative score describing the quality of individual relationships within various types of social networks and other on line communities.

### BACKGROUND OF THE INVENTION

Social networks and other on line communities are booming, yet little is known about the quality of a relationship between two individuals and the reasons why one individual is linked or connected with another, beyond the fact that they simply are connected. Because of this unknown, privacy groups, parents, and many other individuals involved in such on line relationships continue to face the sometimes frightening and often dangerous reality that the person they connect to may not be who he or she says they are. Moreover, questions persist as to whether the individual on the other side of the network has ulterior or malicious motives for linking or connecting to an individual. Currently, the status of any individual in an on line social network is primarily related to the number of links or connections he or she maintains with other individuals in the network. More links typically means higher status, while little or no additional criteria is taken into consideration with respect to determining the quality of a link or connection between two individuals in such a network. In fact, most reputation scoring targets individuals involved in a connection (individual x or individual y), and not the relationship (x-y) between such individuals. In addition, little is known about the context in which such individuals are connected. Is x the friend of y? Is x the employer of y? Is x the son of y? We generally do not know and hence are unable to extract little meaningful information beyond the simple fact that x and y are linked or connected.

Jay Barnes first coined the term social networking in 1954. The social network is a social structure made up of nodes of individuals or organizations. The structures are indicative of how each of these individuals or organizations are connected. More recently, there have been numerous social networking Web sites. The first known site like this was classmates.com, which began in 1995. Some of the others that have developed over the years are sixdegrees.com, Epinions.com, Ciao.com and friendster.com. Lately, social network Web sites that have been publicized in the news for both positive and dubious reasons are facebook.com, myspace.com and the video Web site youtube.com. The latter few Web sites may be considered as mega social networks breaking the previously perceived barrier of 150 people or entities. This number, known as Dunbar's number, was previously believed to be the limit of social work size. Social scientists will argue that even though the networks are much larger than 150 people or entities, the actual interactions will be limited to 150 entities.

The Social network as a theory differs from traditional sociological studies. Traditional sociological studies focus on the individual actor, or a social networking focus on the interaction between the individuals. In the social networking theory it is the relationship between the actors that is most important. It is believed that as more of the world has access to the Internet, social networking will become much more important. It is clear that it is impossible for any single individual to know everyone else. However a single individual can have a considerable affect on their particular network, and that network can have a substantial affect on other networks, and therefore the world. Although social networking discounts the actual importance of the individual, it also serves to amplify each individual's importance in that that individual's ability to affect his or her network is increased through the power of the network also known as the network effect.

In the past, when an individual is applying for a mortgage, credit in some other manner or is applying to be a member of a particular institution, there have been few methods for judging that individual beyond their financial credit score and what they put down in their resume. The same limits are involved in other social networks. Despite the advent of the Internet and the subsequent mass use of social networks via computers, attempts at measuring such interpersonal data continue to be focused on the individual and not the relationship to each other.

Therefore, there is a need for a mathematical method that can collect and analyze not just data surrounding the individual aspects, but also provide a unique score describing the quality of a relationship as a whole within the framework of different social contexts.

This need is extended to all types of social contexts, including but certainly not limited to social, professional and family and the various sub contexts thereof such as father-child, etc. A method such as this would help alleviate many concerns and provide much more detailed information than that revolving around individuals. Instead, this type of method would delve into the quality of the relationship between the individuals and the reason why these individuals are connected. Moreover, the need exists to go beyond the current methods of reputation scoring of individuals and instead the relationship between them. Previously unknown contextual elements would be revealed with a new, unique method of scoring that bypasses such usual hindrances as large social network management. As described below, nothing else compares with the unique aspects of the present invention.

U.S. Pat. App. Pub US 2002/011646681 published on Aug. 22, 2002, is a method that analyzes organizations' existing messaging infrastructure in order to provide management with insight into the interpersonal interactions of people within the organization. Unlike the present invention, this method exclusively relies on electronic mail messages within one organization to the point where the scoring is based upon how many people link to each individual, i.e. the size of that individual's network. Furthermore, unlike the present invention, the type of scoring deduced by this method focuses on the individual rather than on the relationships between individuals in no small part because this method is designed to look into electronic communications rather than taking into account other relevant parameters.

U.S. Pat. App. Pub. US 2006/00424831 published on Mar. 2, 2006, is a method and system for evaluating the reputation of a member of a social networking system. Unlike the present invention, this method provides a score by relying in large part on views from a member's profile, which has the effect of generating a score based on the individual rather than on the relationships between individuals.

PCT WO 2005/071588 published on Aug. 4, 2005, is a method of rating associations between two individuals on a network. Unlike the present invention, this method relies primarily on peer ratings as well as invitation acceptances to the point where the scoring is based on the individual rather than on the relationships between the individuals.

PCT WO 2005/072315 published on Aug. 11, 2005, is a system for displaying navigation of a social network that relies on a method for ranking and displaying profiles for members of the network in order to help members to be able to visualize connections and relationships therein. Unlike the present invention, this system focuses on such limiting individual characteristics as logon date and profile updates as opposed to the unique and much more in-depth items used by the present invention to analyze much further into the overall relationships rather than merely the individual.

A need has been established for a unique method and system that goes beyond merely scoring various cursory elements regarding an individual, but in essence takes many factors into account to ultimately measure the quality of the relationship on a social network. The present invention uses such a method to conduct a thorough evaluation of individuals on how they are conducting themselves in the context of their relationships as opposed to the other limiting and inherently individual factors that previous methods have incorporated. Therefore, the present invention thus satisfies the need for greater transparency and social network reliability by taking those extra steps to measure the quality of the relationships and also to provide a process for the scoring of the relationships between individuals in addition to the individuals themselves.

### SUMMARY OF INVENTION

The present invention is comprised of systems and methods for the evaluating, measuring and scoring of social relationships and the individuals involved in such relationships in regard to a social network. The present invention utilizes a number of different contexts, metrics and ratings methods to create a more comprehensive, detailed understanding of such relationships and the individuals involved. One aspect applies several means for the collection of relevant data parameters that are used in evaluating and scoring a relationship and its individuals. Numerous characteristics and benchmarks are analyzed throughout the process. An additional element of the present invention comprises of methods and systems for rating the relationships or relationship vectors between two entities or individuals in a variety of contexts and for the capturing, collection and aggregation of third party opinion data that is used in calculating a relationship score. Moreover, a further additional aspect comprises of methods and systems for calculating a score from different benchmark and collected data for describing the quality of a particular relationship and the individuals involved in such relationship within the framework of different relationship contexts. This includes but certainly is not limited to social, professional or family contexts.

Such score are comprised of subjective and objective parameter collection and data capturing methods. In fact, the present invention employs a number of features into the system and method. While the present invention creates a score for individuals within a particular social network, it determines these numbers based upon the relationships between the individuals within the social network as opposed to limiting itself to particular information about the individual. Of course all of the information pertaining to the individual is also available to the current invention and as such may be used. But the present invention also is able to gather anonymous data. Anonymous data is that information which can be gathered when a user has not registered or logged in. It should be noted that anonymous data is used by the present invention differently. For instance, Web pages that are participants or as part of the network, will allow the logging of where anonymous users go. An anonymous user may look to particular posts and these posts may have particular keywords associated, which would then be associated with that anonymous user. Particular IP addresses also can be associated with that particular user, as this information is easily gathered. Of course, since all of this information is anonymous and not associated with any particular entity, no actual scoring will take place. That is until the user can be later identified by the anonymous data that was collected and the personal data that the user may disclose at a later time by registering with a social network site that participates in the social relationship scoring network (SRSN). From there, personal data can be mapped or correlatated with the previously captured anonymous data beyond any reasonable doubt.

When someone registers they are no longer an anonymous user. Along with the numerous other factors, the present invention also takes into account different levels of registration. The most basic level is where the user/participant merely has a username and password and provides no additional information about him or her. In such a case, that user can be scored but it should be noted that none of his or her particular information will be made part of the score. In many ways, this level of participation is at the core of the present invention as the only information that can actually be consistently gathered is that of their interactions with other users. In such a case, the system will note which profile the user reads, how, if, and how often the user rates and views a particular profile or the relationship between two profiles, as well as all the anonymous data which can be gathered.

When a user registers and puts in more information about themselves than just a user name and password, this information may also be used as part of the rating system and to identify other previously collected activity data that was not associated with a user's profile. It should be noted that the purpose behind the rating system is to look for trustworthiness, stamina, integrity, reliability, and compassion and several other factors as a substitute for the rating systems provided by other companies.

### BRIEF DESCRIPTION OF THE DRAWINGS

FIG. 1 shows a summary flow chart of the present invention.

FIG. 2 shows a flow chart of the basic relationship rating and scoring process.

FIG. 3 shows a flow chart of the profile data collection and scoring process.

FIG. 4 shows a chart of relevant profile update algorithms.

FIG. 5 shows a flow chart of the tool bar and plug-in collection and scoring process.

FIG. 6 shows a flow chart of the registered user data collection and scoring process

FIG. 7 shows network diagram of the social relationship and association scoring network

FIG. 8 shows a diagram of the profile relationship and properties

FIG. 9 shows a basic data model of the present invention

FIG. 10 shows the client-server architecture of the social relationship scoring network

### DESCRIPTION OF THE PREFERRED EMBODIMENT

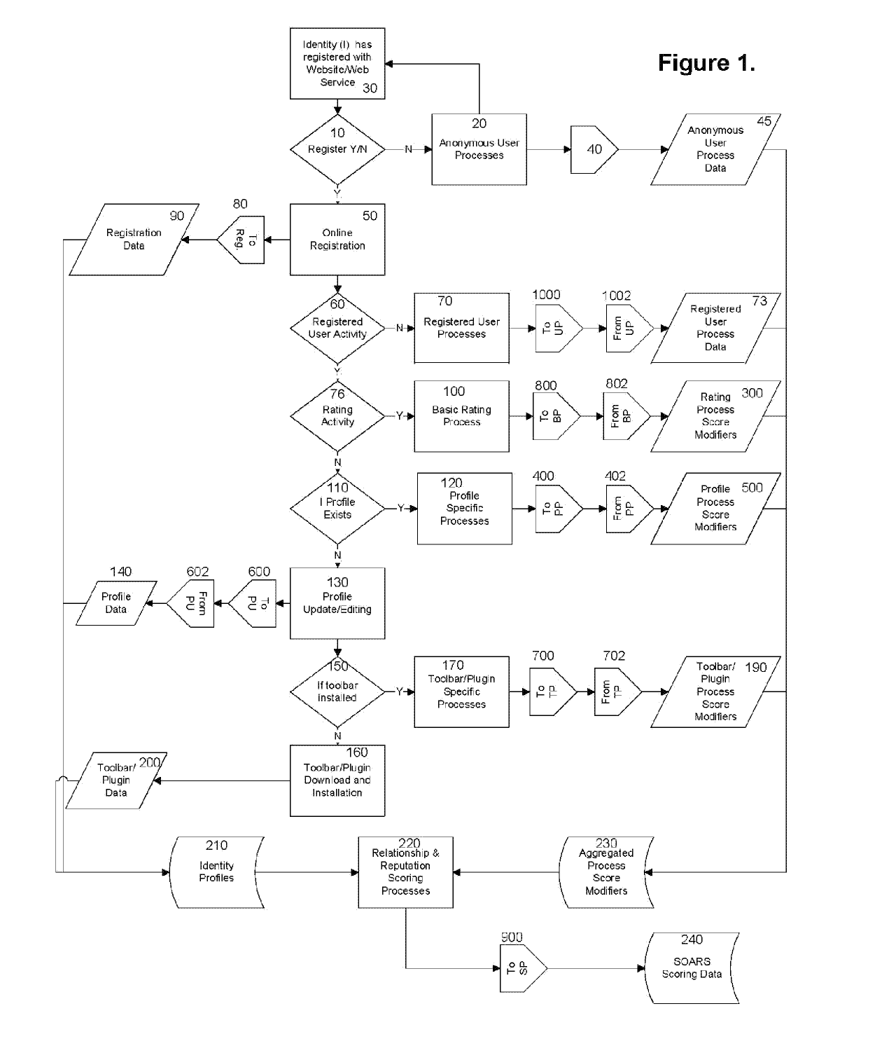

In FIG. 1, we see a flow chart of the entire social on line association and relationships scoring system (SOARS). The process precipitating the present invention begins with a user accessing a Web page. However, there are several methods relating to the present invention that condition the process on such factors as depending on where the user accesses the scoring system (e.g. social extranets, local social nets, web service access through tool bar, plug-in or browser client). In general, the system will attempt to identify the user by asking if that user is registered (10). If the user is not registered and he or she is considered an anonymous user (20) then it is processed accordingly. The present invention processes this information and gathers the anonymous user process data (45). This data will be used to affect the aggregated process score modifiers (230) that are used for the relationship and reputation scoring processes (220).

FIG. 1 further shows that if the user does have a user name and password, or other unique identifiers that are understood by the SOARS system such as an email address or user id, then the user is identified as being registered with Web service (30). It should be noted that if the user does not have a user name and password or cannot be identified through other means, they are provided the opportunity for on line registration (50) through the registration process (80). When a user registers, registration data (90) is gathered. The user has the option to merely enter a user name and a password, or they may provide more information about themselves, which might include their credentials on other social on line community sites, or additional profile detail information. Whichever they do, a new SOARS profile is set up for this user in terms of profile data (140) and registered user process data (73) begins to be gathered immediately through the registered user processes (70, 1000). Once registration is confirmed and the identity of a user has been established, they will be further subjected to the basic rating and scoring process (800) every time the system detects rating activity (76) for that registered user.

FIG. 1 further shows how a registered user might decide to provide additional profile data that might consist of personal details such as home address, hobbies, and other personal data as well as login credentials for Web sites and social networks that the user might participate in or already maintains membership. All such additional information will be used in collecting SOARS profile data and correlate such profile data with profile data that is stored on participating Web sites. Such external data will be periodically updated (600) and synchronized through the profile specific processes (120, 400). Any new data that is collected through the profile process (400) result in profile process score modifiers (500) which will modify the aggregated process score modifiers (230) to alter the relationship and reputation scoring processes (220) of one or more users which score are stored as SOARS scoring data (240).

FIG. 1. further summarizes how a registered user might decide to download and install a Web browser tool bar or MICROSOFT OUTLOOK™ plug-in that is installed on the personal computing device of a user. In this instance, a plug-in or tool bar will perform additional data collection tasks, which will result in the creation of tool bar and plug-in process score modifiers (190) that are used on the relationship and reputation scoring processes (220) to alter the SOARS scoring data (240).

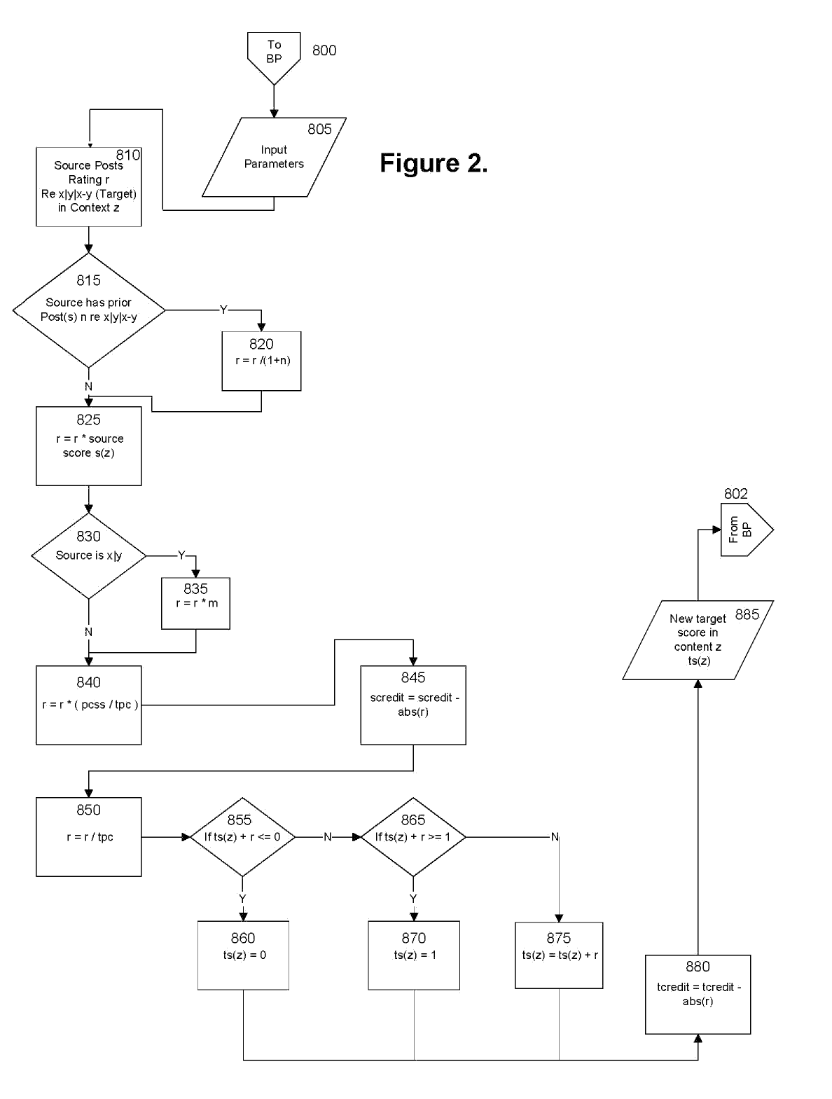

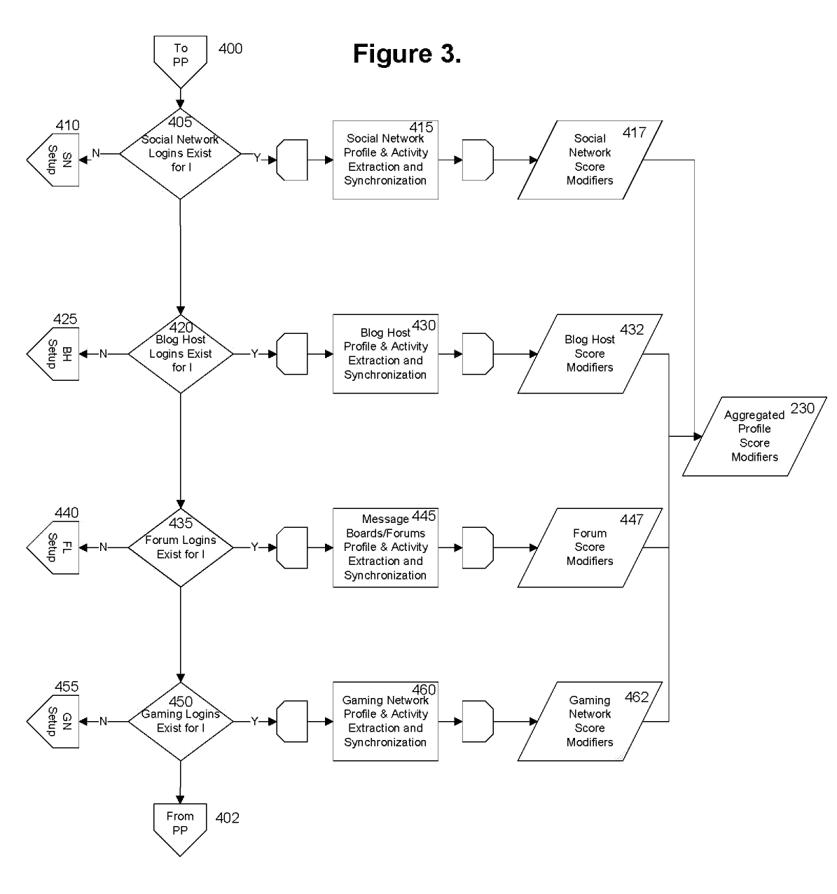

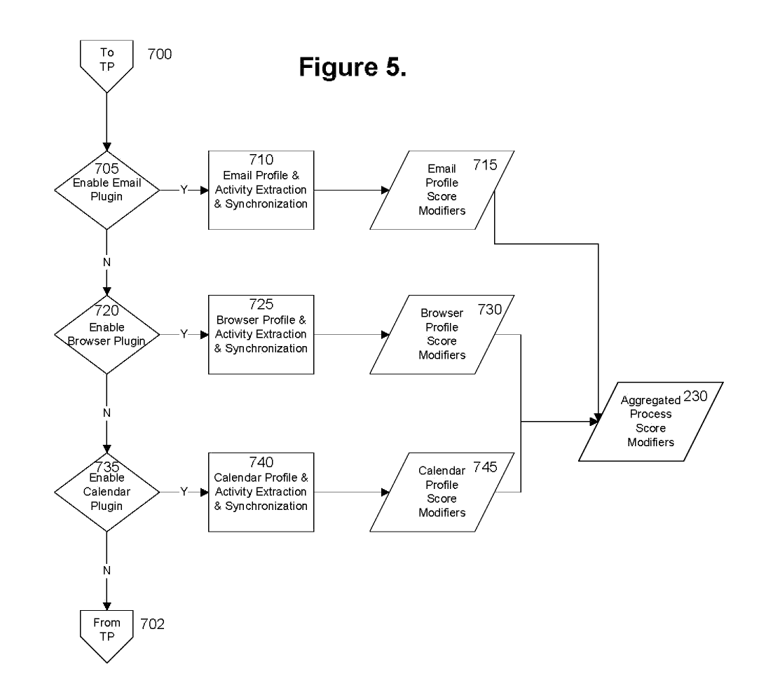

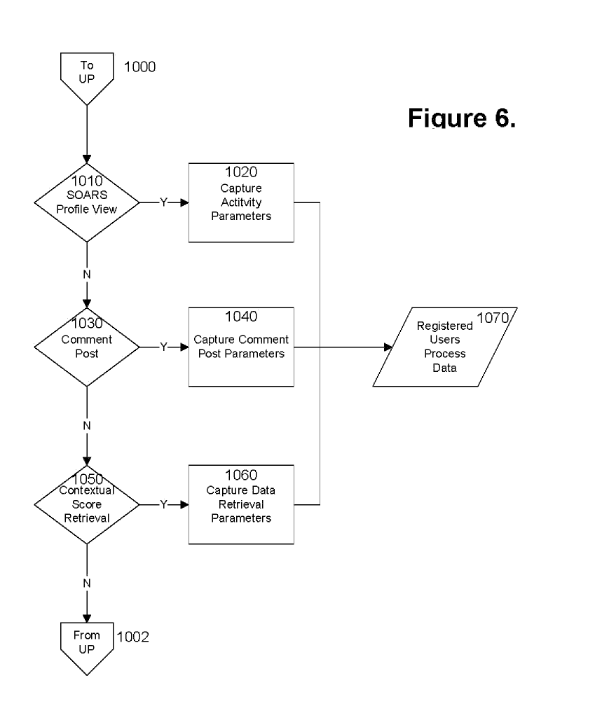

FIG. 2 shows the basic rating and scoring process (800) that is triggered when the system detects rating activity (76). The process of gathering user or registration data (90), profile data (140), and tool bar and plug-in data (200) to update the identity profile (210) is done continuously. Subject to what information is gathered, the registered user data updating process (1000), profile process (400), or the tool bar and plug-in update process (700) is used. All of these are described in more detail in FIG. 6, FIG. 3, and FIG. 5 respectively.

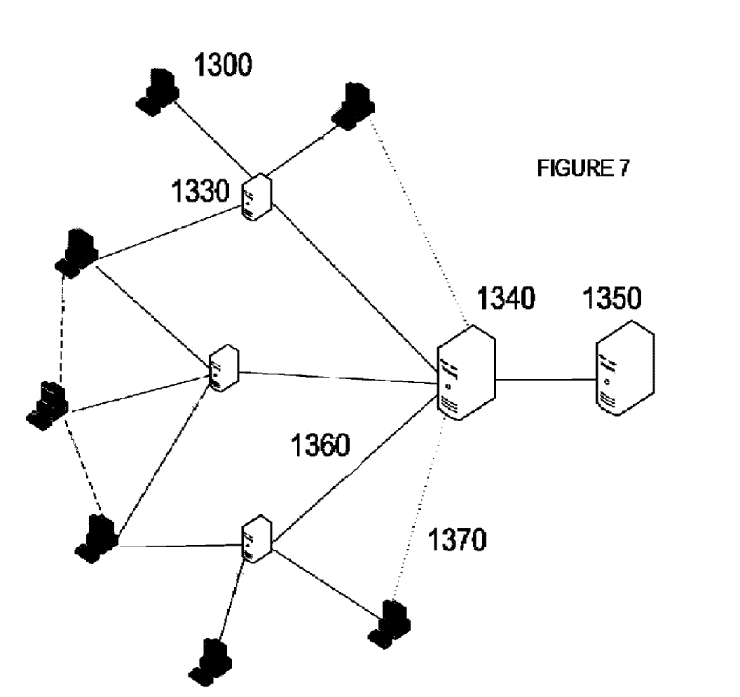

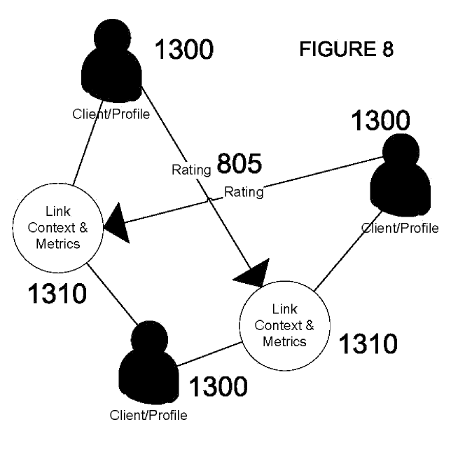

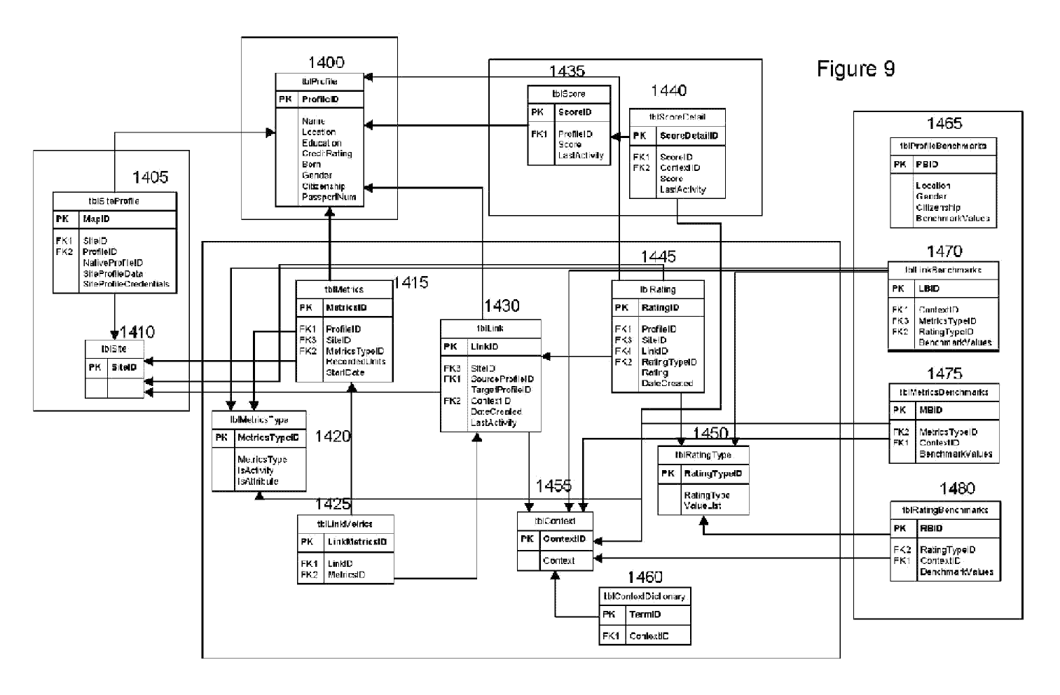

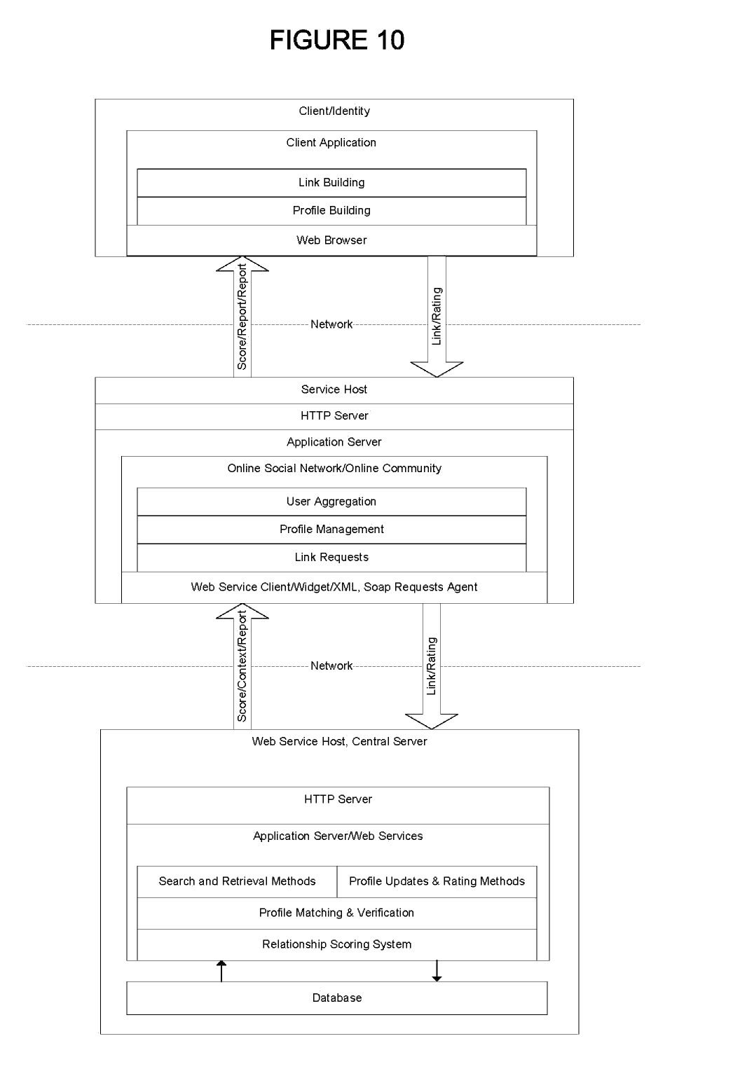

Additional figures in FIG. 7, FIG. 8, FIG. 9, and FIG. 10 demonstrate the nature of the social relationship network, how the collected information is stored and interrelates the algorithms and mathematical process as the present invention is designed to take a multitude of informational elements into account in order to make the most accurate and contextual score.

FIG. 3 shows that the scoring related to the profile process (400) begins once a user has decided to setup or update (410, 425, 440, 455) their user profile with login credentials to community Web sites that are participating in the SOARS network and external sites (1410). Such Web site credentials might include social network logins (405), blog host login (420), forum login (435) or message boards, or even gaming network logins (450) that a user might participate in or already is a member. Once the user being scored has provided one or more social network logins (405), the scoring process of the present invention as shown in FIG. 3 takes into account the social network profile(s) of the user in such social networks. It also will continuously extract and synchronize the user's profile and activity in such social network (415), store such information in a profile table (1400) and calculate new or amended profile process score modifiers (500) that are used in the reputation and relationship scoring processes (220) that will ultimately affect the SOARS scoring data (240). Similarly this in turn leads to the blog host profile information gathering process (430). However, the user must have provided one or more blog host login (420), which in turn leads to the forum and message board profile information gathering process (445) if forum login(s) (435) are known for the user, and the loop ultimately terminates with the game network information gathering process (460) in the event game network login(s) (450) are known for a user. All of these processes will be used to gather and update one or more user profiles in a profile table (1400), the associated profile metrics (1415), the associated profile link data (1430) and the corresponding benchmark data (1465, 1470, 1475, 1480). This information is then used to create additional profile score modifiers that are mathematically derived from any new information that the profile processes are able to retrieve in comparison to the information gathered during the last profile process cycle.

FIG. 5 shows that the process for the tool bar and plug-in update (700) begins once a user has completed the tool bar/plug-in download and installation (160). The tool bar/plug-in consists of three primary process components and a user has the option to enable or disable each component to start or stop data collection processes and scoring processed related to each component. Enabling the email plug-in (705) will start the email profile and activity extraction and synchronization process, which is continuously collecting information from an email client that is installed on a user's PC or from a user's web based email account. The email plug-in process will gather statistics related to a user's previous and current email activity in order to generate and store relevant metrics (1415) and update link data (1430) that is used in creating email profile score modifiers (715) for the reputation and relationship scoring processes (220). For example, resulting information might include the frequency with which a user communicates with another or the context (1455) of their correspondence that is determined by matching the correspondence with dictionary terms stored in the context dictionary (1460). Enabling the browser plug-in component for the tool bar/plug-in will start the browser profile and activity extraction and synchronization process. These events continuously collect information and statistics about the Web pages a user visits and the information is used in updating the link data (1430) and activity metrics (1415), as well as corresponding benchmarks (1470) and (1475) respectively. At the same time, it enables the calendar plug-in to be collected and synchronized with one or more user profiles with the contextual event information a user has or will participate in. All this new information will be used in calculating browser related score modifiers (730) and calendar related score modifiers (745) that will be used in calculating the aggregated process score modifiers (230) used in the reputation and relationship scoring processes (220).

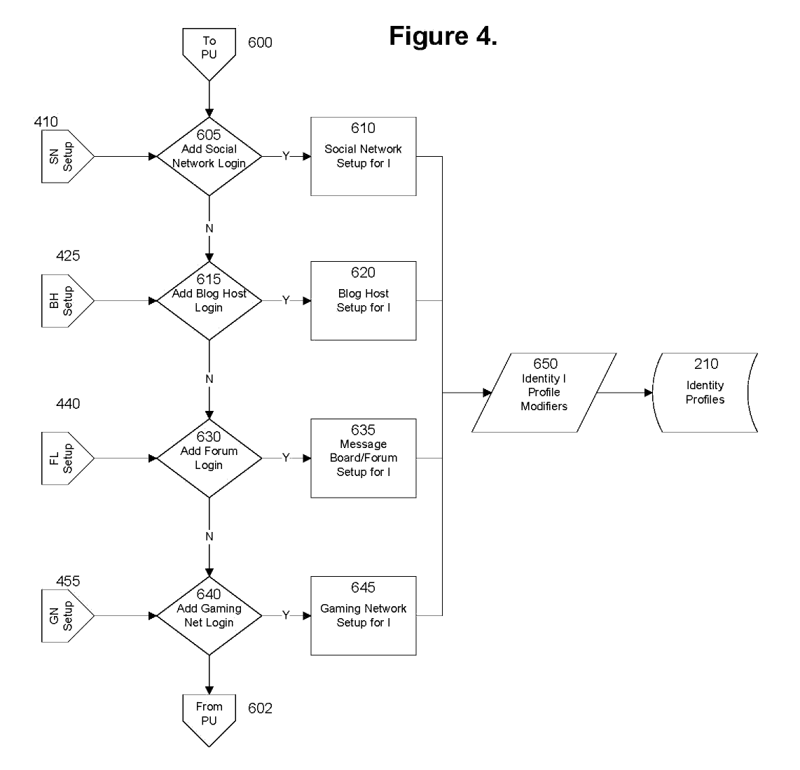

The data collected during the tool bar/plug-in processes in FIG. 5 and the profile update and scoring processes in FIG. 3 and FIG. 4. are further used to match any information that was previously unidentifiable or could not be matched or mapped to specific user profile information. For example, little might be known about the relationships of a registered user. However, as this user will enable the email plug-in process or provide membership login credentials to one or more social network sites, data can be extracted and matched between this user and other user's profiles, or the data will be simply amended and stored for later comparison.

FIG. 9 shows the basic relational data model of the present invention, which consists of the various tables and the relationship between such tables and the information they contain. All the profile information and the information that is collected and tabulated during the previously described processes will be stored and represented in the relational data model. At the root of the model is the profile table (1400), which is used to store location, gender and other user related information that is native to the scoring system. Each native profile has a unique identifier through which other related tables are joined to such profile to provide more in-depth information. The native profile table is related to external site profiles (1405) of sites that are participating in the scoring network and external sites (1410). These are generally of a certain type such as a blog, social network, forum or gaming network. The external site profiles are used during the profile process (400) to automate the collection and synchronization of profile scoring information (415, 430, 445, 460) that is used to create score modifiers (417, 432, 447, 462). Another related profile table is the metrics table (1415), which stores information about a variety of different profile metrics that are of certain metrics type (1420). Many different metrics are used in createing score modifiers that will affect the sub scores (1440) and the aggregate relationship score or resulting score (1435) of the user. One metrics is the number or links a user maintains on the scoring network and external sites (1410), another is the number of emails a user has received between a particular time in the past and the time of measurement. Metrics also can be related to and associated with the link table (1430) through the link metrics-mapping table (1425). The link metrics-mapping table (1425) is the element of the present invention that is used to store all relationship vectors that the scoring system has identified, whether they are native to the system or external to the system and exist on the scoring network and external sites (1410). Each link consists of the profile identification of the source user and the profile identification of the target user involved in the relationship. Links are bi-directional (e.g. source is father of target and target is son of source) depending on the context (1455) of such link. Other information regarding the link is defined through link metrics mapping table (1425) such as the number of times the source has sent an email to target or the number of times source has posted a comment on target's blog host login (420), as well as link ratings of the rating table (1445). Several rating systems (1450) can be taken into consideration, as they are stored in the scoring process. Most of these are external to the scoring system and are managed on external sites. However, the primary basic rating and scoring process (800) provides the main method for a third-party profile to evaluate a link between a source profile and a target profile.

Another group of tables that contain important information used in creating score modifiers and the resulting scores (1435) and sub scores (1440) are the benchmark tables (1465), (1470), (1475) and (1480). The benchmark tables are derived from the profile table (1400) and its related tables, the metrics table (1415), the link table (1430) and the rating table (1445). The benchmark tables store aggregated profile information that is grouped in a variety of different ways to provide the mathematical basis for the calculation of aggregated process score modifiers (230), score generation and relationship and reputation scoring processes (220). The link benchmarks are grouped by context (1455), metrics type (1420) or rating type (1450). This is in a similar fashion for how the metrics benchmarks are grouped by context and metrics type and rating benchmark are grouped by context and rating type. The profile benchmarks are grouped by location, gender, citizenship, age and a variety of other factors. Each table contains benchmark values such as the value boundaries (e.g. highest and lowest values), and the average values and standard deviations for each grouping.

The present invention scores relationships as opposed to merely individual aspects. FIG. 3 shows how items, such as the add network login (605), add blog host login (615) add forum login, among others, have a relationship and interact to/with the individual. These interactions are measured and used by the present invention. For example, FIG. 3 explains how a person with a relationship to the individual in the context of add blog host login (615) would be taken into account in association with the blog host setup for an individual (620). While FIG. 3 is a demonstration for the profile scoring process, FIG. 4 shows the actual mathematical algorithms of the social on line association and relationship scoring method contained in the present invention. This mathematical method is the one that is currently preferred. It should however be understood that this formula is just one method showing how the relationships may be analyzed. Over time it is believed that data from the system will force changes to this formula in order to more accurately reveal the truth of the social interactions/relationships. However, any formula changes will continue to (just the same as items are taken into account as seen in FIG. 1 through 3) place numbers into various areas of interest that are both broad and unique to social on line relationships and as the on line world changes those things that are taken into account will change. Core process variables and profile process variables in the chart that makes up FIG. 4 include such topics as demographics and profile information. These are complimented by numerous sub-elements as FIG. 4 demonstrates. Numbers of various amounts are associated with each area of FIG. 4 allowing for the desired range and type to be taken into account. FIG. 4 also uses numbers in the process for both individuals and those with relationships to the individual. FIG. 4 shows how the present invention currently takes all of these numbers and factors into account through such areas as input parameters, data type and score generation to mathematically assign a meaningful scores. As discussed above the actual method will dynamically change as data is gathered and as the on line world changes. What will not change is that there will be a method for judging the relationships between different people.

### Description of Scoring Method

As the figures demonstrate, the scoring system captures data from a variety of sources. As these items are used, mathematical algorithms in essence tabulate these different elements and ultimately create score modifiers that create or alter a score based on the social on line relationship and its context.

As mentioned above, scoring begins when a person enters a participating Web site. The user will be permitted to peruse free sections of the Web site and if the user wants to go further, then the user will have to log in. If he or she is not logged in, they will have to register (10) and profile data (140) is created and stored in a profile table (1400) and its related tables.

The present invention will look at the patterns presented by anonymous users. The system will tell a viewer if someone looks at profiles, develops relationships/links, rates relationships, identification of IP addresses correlated to regions, time length of visit, etc. In relation to the actual scoring, this information will be used to gauge the popularity of particular profiles and the relationships or links between them. There can be no actual scoring of anonymous users although the present invention takes the information into account for later retrieval and mapping purposes as more data becomes available over time. On the scored side in regard to registered users, there can be different levels of registration. Basic is defined as just user name and password. Under this basic area, the present invention allows the scoring of such items as where someone goes, what he or she posts, what profile he looks at and whom he or she is rating. The basic activity parameters (1020), post parameters (1040), retrieval parameters (1060) and ratings are considered in the basic rating and scoring process (800) through the use of input parameters to the mathematical algorithm. This includes items such as identity, the context (professional, social or family), the source of the post/rating, the person that makes the post/rating and all of the other information available from the anonymous set and from the registrations process (age, location, gender, etc.)

Because the present invention is intended to score deeper social contexts and interactions, more than one scoring mechanism is used. Alternative algorithms and methods are show in the figures attached herein. For example, a rating in 810 which is effectively a thumbs up, thumbs down or neutral opinion regarding a person or relationship is included, ultimately leading to three types of values which will then be used to calculate the aggregated process score modifier (230). Regarding 815, if there are prior posts/ratings on that relationship, then those prior numbers are taken into account in 820. In 825, the spread sheet which is effectively a basic scoring calculation starts at line 17. In fact, in its current incarnation, everyone subject to the present invention starts off with a particular score. An example of this could be that these beginning users could be in the middle at 0.5 with a top score of 1 and a bottom score of 0.

In 830, the source is one of the people in the relationship. The present invention, taking this fact in to account, lowers the score down a percentage because the person is part of the relationship and is biased. In 840, the present invention takes into account such items as the total number of posts/ratings. In 845, the present invention calculates a user's credit in terms of how many times he or she does ratings. In this respect, if a user does a lot of ratings then the user is taken less seriously and the impact of the rating is diminished as more ratings are undertaken. In 850, the rating is again divided by the post/rating count. In 855, if the resulting score is less then 0 then it ultimately becomes 0. Still, as in 875, the present invention takes old ratings and adds the new ratings to it. In 880, if one gets a negative score, then the target that is being scored has credits as well, so the target gets more credit because someone is actually scoring them. This means that the more relevant the rating is for a particular relationship or individual, then the less deductions from the personal rating counter take place.

In respect to credits; each person starts with a certain number of available posts/ratings. When commenting on other people or relationships, the commenting person's credits will be reduced a percentile smaller amount the closer the original rating stays to the new rating. People who are part of the system will obtain credits by inviting others into the community, by being rated (they get the amount of credit that is the same as the impact of the rating), by starting a post/rating (they get one point if some one else comments on that post), and in numerous other ways. In 885, the new target score is passed back into the main system (402). In 500, the information passed from BP is added in to the other modifiers.

### Description of Relationship Scoring Network

FIG. 7 describes a higher view of a physical social network architecture that interfaces with the SOARS scoring system. Everything starts with the central server (1350) which houses the social networking analysis engine/software and the profile data used by this engine. This server (1350) is connected to the Internet via a high bandwidth web service host (1340) which host exposes all the relevant system functions through xml web service methods which collectively form an application programming interface (API) that is consumed by native web applications, toolbar and browser plugin clients, as well as all participating social networks (Service hosts) (1330) that interface and share information with the social scoring network and indirectly offer certain functionality of the scoring network to their own users. All of the users of the system, the clients (1300) are connected to the Internet via their own Service hosts (1330). The present invention, as currently designed uses XML/SOAP protocols (1360) between clients and the web service host to pass information to and from the central server through the use of the IP system (not shown) normally used on the Internet. Of course the client systems will have greater capabilities if the user has installed the optional tool bar (200) and its associated update processes (700). The present invention is dependant on the central server (1350) for all social networking analysis and relationship scoring. It is however contemplated that a peer to peer system which allows hosting of the analysis engine on client machines. This would of course change FIG. 7 in to a standard peer networking view.

FIG. 8 shows the internal workings of the system where there is a client profile (1300) which interacts and is modified by systems but never directly with another client profile (1300). The systems which will do the modifications to the client profiles (1300) will be one which analyzes the link context and the metrics and which will result in new ratings (805) for a particular client profile (1300). FIG. 9 is a more detailed view of the Database which does the analysis. The tblprofile (1400) is where all of the resulting data is stored. The tblsiteprofile (1405) is the depository of the profile data re the numbers which identify a particular website site. It (1405) passes its information to both the tblprofile (1400) depository and the tblsite (1410) which is the location data of the site itself [Oliver, I am lost on this figure—Help!!!!!!!!!!!!]

FIG. 10 shows the current invention as a layered diagram. [Oliver, I am lost on this figure—Help!!!!!!!!!!!!]

### Additional Embodiments Regarding Scoring Method

Another aspect of the present invention is the scoring of the relationship between an individual or identity and an organization or, alternatively, the relationship between an organization and another organization in context. The scoring of such relationships will be based on ratings by either one of the parties involved in such relationship, or based on the rating of the relationship by a third party, in which the third party may either be an identity or an organization that is not directly involved in the relationship that is under review and which the relationship's score will be affected by such rating.

For example, a customer of an organization may qualify in an encounter in purchasing products or services from by applying a rating to such experience. Some of the following questions, among others, could be asked. Were the products delivered as promised? What was the quality of the customer service that was received from during the transaction? At the same time, one might qualify the relationship: Did the customer pay on time? Did the customer require more than an average amount of service and support from another during the transaction? All of these questions can be qualified by a rating by either an Identity or Organization directly or indirectly involved (an observer of the relationship) in order to determine the quality or score of the transaction and hence the relationship overall. The context of relationships that involve organizations is always professional in nature and breaks down into sub-contexts such as buyer-seller, employee-employer, and licensor-licensee relationships.

Relationship contexts are bi-directional and consist of two inverted context descriptors that define the relationship context between a and b and the relationship context between b and a (e.g. father-son, son-father). Meanwhile, each context descriptor features a distinct sub-score or sub-rating that defines the quality of the particular context. Each context descriptor will further feature a context direction that points from sources to targets. For example, A might be a good father to B, but B is not a good son of A.

The relationship scoring methods underlying the present invention will always consider both parties involved in a relationship to arrive at an aggregated relationship score that is comprised of one or more contextual sub-scores between such parties. While a particular rating might be one directional, and directed at the identity or organization, it is the aggregate of such ratings that will determine the resulting score and thereby define the quality of the relationship overall.

The invention will further consider the score of the rating party in calculating the impact of the rating on the total relationship score. For example, if the rating party has a low score in the context of being an on line retail customer, the ratings or votes will have a diluted impact on any relationships that one will rate or vote on that are in the same context.

Also, if an individual or organization are third parties that are rating a relationship that one is not directly involved in, and whereby one might be the husband or otherwise biased by one the parties involved in the relationship, then the rating will be diluted as well, due to the obvious bias that is likely to propel one to issue a rating that will favor his spouse or closely aligned individual. It is this method of rating degradation based on the context and relationships between the parties that are rated, and the rating parties that will ensure that the resulting scores will be a more accurate reflection of the relationships that are rated (rating temper protection).

Especially when we compare the methods and systems of the present invention to traditional rating systems that are in use today, inherent flaws are prevalent regarding the one-directional rating approach. Not only can an overall rating or score in a one-directional system be more easily skewed by a few malicious votes, but more importantly, one-directional systems generally provide no insight into the motivation behind, the relationship between, or the personal make-up of the party that is issuing the vote to the party that is receiving the vote. For example, a movie's 5 star rating may consist of 10×5 star votes, while two repetitive 1 star votes from a malicious voter or possibly a competitor or disgruntled employee will have a significant effect on the overall rating of the movie, if one applies the traditional rule of averaging (total number of stars/number of votes). Not only will the movie score be unfairly affected, the movie score also provides no further context and no further transparency for how the score or rating was derived. And a casual viewer of the movie score will not only be unknowingly mislead by the malicious ratings, but the viewer will further not be able to differentiate whether the votes that were issued came from like-minded persons or from persons that the viewer has little in common with. This in turn will severely impact the relevance of the overall rating for the viewer.

Primarily, the present invention is a necessary and useful method and system that goes beyond the typical individual ratings in order to provide a vastly more accurate and in-depth analysis of relationships in social networks. The present invention fits the need to use mathematical systems and methods to look into how people actually conduct themselves in a social network relationship and the context in which these relationships operate. The present invention incorporates algorithms and an all-encompassing system to garner all of this unique and additional information in order to reach such an in-depth, informational and useful rating. The practical applications for anyone involved or concerned in not just business, but also social networks in general, are enormous. The detailed scope of the analysis that is undertaken by the present invention provides a much needed and unique method for those with even a cursory involvement in social networks. [should we talk about some specific benefits, applications e.g. the stuff listed in the powerpoint?] It is to be understood that the present invention is not limited to the sole embodiment described above, but encompasses any and all embodiments within the scope of the claims.

I claim:

1. A method for obtaining a unique score for online relationships comprising:
collecting data; and
creating a first score, based upon said data, for online relationships between parties.

2. The method of claim 1, further comprising displaying a user's social relationship score on the user's profile page to identify the user's trustworthiness and reliability.

3. The method of claim 1, further comprising filtering or blocking new users in social networks based on their social relationship score.

4. The method in claim 1, further comprising mapping user profiles and relationships of users between multiple social networks.

5. The method in claim 1 wherein a first score is used to create a second score for a party.

6. The method in claim 1 wherein vectors between parties are used to calculate a first score and a second score.

7. The method in claim 1 further comprising using third party opinion data to calculate a first score and a second score.

8. The method in claim 1 further comprising mapping user profiles and relationships of users between multiple social networks.

9. The method of claim 1 further comprising mapping user profiles and relationships of users according to quality of each particular relationship.

10. The method of claim 1 further comprising mapping user profiles and relationships of users according to the individuals involved in a particular relationship.

11. The method in claim 5 wherein a relationship context is used to create the second score.

12. The method in claim 5 wherein contextual relationship sub-scores are used to create the second score.

13. The method of claim 5 further comprising modifying the first score and the second score via anonymous data or private data.

14. The method of claim 5 further comprising modifying the first score and the second score via credit reports.

15. The method of claim 5 further comprising modifying the first score and the second score via logged anonymous data which later is identified with a particular individual or entity.

16. The method of claim 5 further comprising modifying the first score and the second score via ongoing user interactions.

17. The method of claim 1 further comprising gathering data about a user's online relationships with individual and entities via a toolbar.

18. The method of claim 1 further comprising mining a user's email history to extract relationships as well as the frequency, longevity, and depth of relationships.

19. A method online communication, comprising:
registering participants;
monitoring particpants' opinion data, quality of relationships, personal data, and credit reports;
creating a score based upon the data; and
weighting vectors associated with the data.

20. A method for obtaining a unique score for online relationships comprising:
collecting data; and
creating a first score, based upon said data, for online relationships between parties;
displaying a user's social relationship score on the user's profile page to identify the user's trustworthiness and reliability;
filtering or blocking new users in social networks based on their social relationship score;
mapping user profiles and relationships of users between multiple social networks;
wherein a first score is used to create a second score for a party;
wherein vectors between parties are used to calculate a first score and a second score;
using third party opinion data to calculate a first score and a second score;
mapping user profiles and relationships of users between multiple social networks;
mapping user profiles and relationships of users according to quality of each particular relationship;
mapping user profiles and relationships of users according to the individuals involved in a particular relationship;
wherein a relationship context is used to create the second score;
wherein contextual relationship sub-scores are used to create the second score;
modifying the first score and the second score via anonymous data or private data;
modifying the first score and the second score via credit reports;
modifying the first score and the second score via logged anonymous data which later is identified with a particular individual or entity;
modifying the first score and the second score via ongoing user interactions;
gathering data about a user's online relationships with individual and entities via a toolbar; and
mining a user's email history to extract relationships as well as the frequency, longevity, and depth of relationships.
